(19) United States
(12) Patent Application Publication
(10) Pub. No.: US 2008/0055927 A1
(43) Pub. Date: Mar. 6, 2008

(54) Light source efficiency upgrading installation

(75) Inventors: Chin-Hui Chen, Yangmei Taoyuan (TW); Ming-Chuan Chen, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-BRIDGE ELECTRONICS CO., LTD.

(21) Appl. No.: 11/707,254

(22) Filed: Feb. 16, 2007

(30) Foreign Application Priority Data
Aug. 31, 2006 (TW) 095132238

(51) Int. Cl. F21V 7/04; F21V 7/00

(52) U.S. Cl. 362/606; 362/296; 362/608

(57) ABSTRACT

An installation to upgrade light source efficiency includes a dimmer disposed to the backlight module at where in relation to the route the light from light source travels; and the dimmer is related to an optical structure that is totally permeable and/or reflects light to upgrade light source efficiency and more effectively distribute streams of light emitted by the light source by eliminating those dim and dark belts found between any two neighboring light sources in a more active and initiative means to solve problems of lower light source efficiency and creating those dim and dark band as found with the prior art.

### BACKGROUND OF THE INVENTION

(a) Field of the Invention

The present invention is related to a light source efficiency upgrading installation, and more particularly, to one that is capable of upgrading the overall efficiency of the light source and effectively solve the problem of creating dim and dark bands as found with a backlight module of the prior art.

(b) Description of the Prior Art

Usually a direct or side emitting backlight module configuration may be elected according to design requirements for a liquid crystal display (LCD) applied in an information installation. FIG. 1 of the accompanying drawings for a schematic view of a basic construction of a direct backlight module configuration, the construction of the entire backlight module is comprised of a reflection mask 11, multiple light sources 12, a diffuser 13, multiple optical films 14, and a liquid crystal panel 15 in sequence going from the inside to the outside. Wherein, each light source 12 may be related to a lamp made in a straight form, U-shaped, or any other continuously curved form. Multiple light sources 12 are arranged with a proper spacing among one another at where between the reflective mask 11 and the diffuser 13. Those multiple optical films disposed between the diffuser 13 and the liquid crystal panel 15 generally available in the market are comprised of one or up to three diffusers; zero or up two light enforcement films, and zero or one reflective polarized film to diffuse light passing through the liquid crystal panel so to correct the problem of creating dim and dark bands on the liquid crystal module due to absence of light between the interval of two abutted light sources 12.

Whereas the diffuser 13 works only to make sure of constant diffusion of the light passing through it, its results to correct the phenomenon of those dim and dark bands are very limited. Therefore, even though in a certain backlight module a longer spacing between the light source 12 and the diffuser 13 is provided on purpose to expand the range for the light from the light source to enter into the diffuser for reducing those dim and dark bands, its results are very limited and thicker backlight module warranted by the longer spacing between the light source 12 and the diffuser 13 also defies the initial design for a compact liquid crystal module.

### SUMMARY OF THE INVENTION

The primary purpose of the present invention is to provide a light source efficiency upgrading installation to improve the construction of achieving constant radiation of streams of light emitted from the light source towards the liquid crystal panel while the configuration of the basic composition of the LCD works the same to present light source performance results of a light emitting object through optical films and liquid crystal panel.

To achieve the purpose, a dimmer is disposed to the backlight module at where in relation to the route the light from light source travels. The dimmer is related to an optical structure that is totally permeable and/or reflects light to upgrade light source efficiency and more effectively distribute streams of light emitted by the light source by eliminating those dim and dark belts found between any two neighboring light sources in a more active and initiative means to solve problems of lower light source efficiency and creating those dim and dark band as found with the prior art.

### BRIEF DESCRIPTION OF THE DRAWINGS

FIG. 1 is a schematic view showing a construction of a backlight module of the prior art.

FIG. 2 is a schematic view showing a construction of a first preferred embodiment of the present invention.

FIGS. 3(A) and 3(B) are perspective views respectively showing a construction of a second preferred embodiment of the present invention.

FIG. 4 is a schematic view showing travel of streams of light in a third preferred embodiment of the present invention.

FIG. 5 is a schematic view showing travel of streams of light in a fourth preferred embodiment of the present invention.

FIGS. 6(A) and 6(B) are schematic views respectively showing a construction of a fifth preferred embodiment of the present invention.

FIGS. 7(A) and 7(B) are schematic views respectively showing a construction of a sixth preferred embodiment of the present invention.

FIG. 8 is schematic view showing a construction of a seventh preferred embodiment of the present invention.

FIG. 9 is schematic view showing a construction of an eighth preferred embodiment of the present invention.

FIG. 10 is schematic view showing a construction of a ninth preferred embodiment of the present invention.

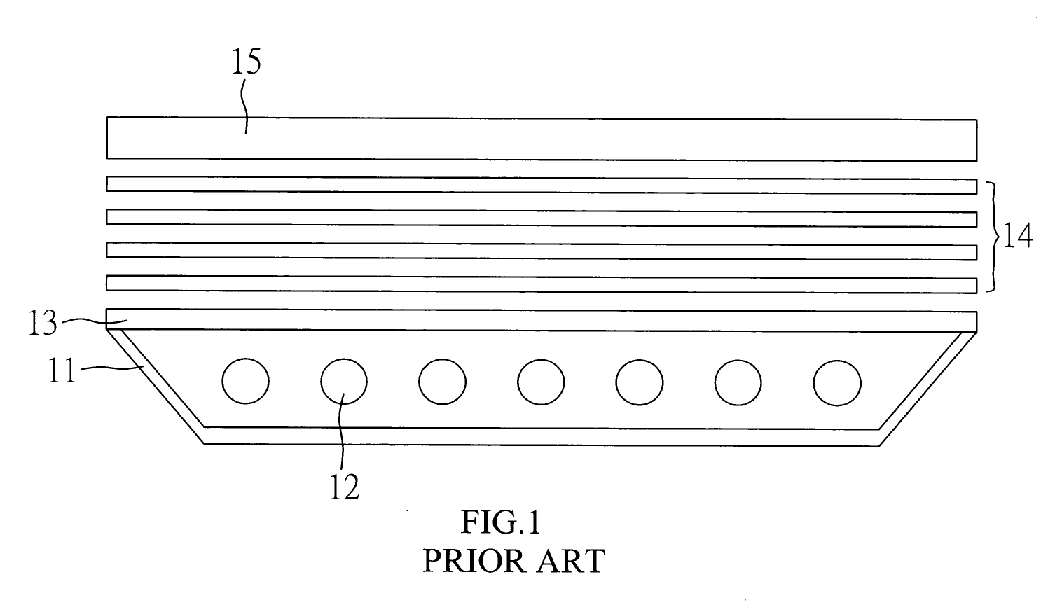

### DETAILED DESCRIPTION OF THE PREFERRED EMBODIMENTS

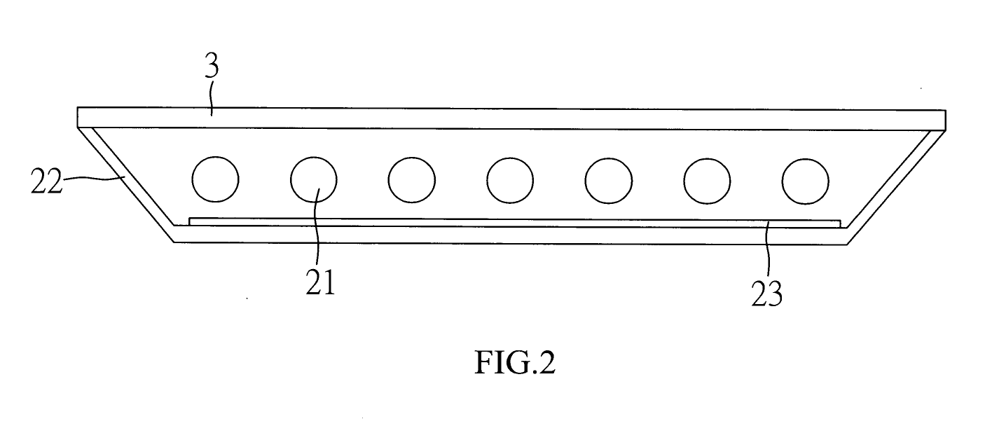

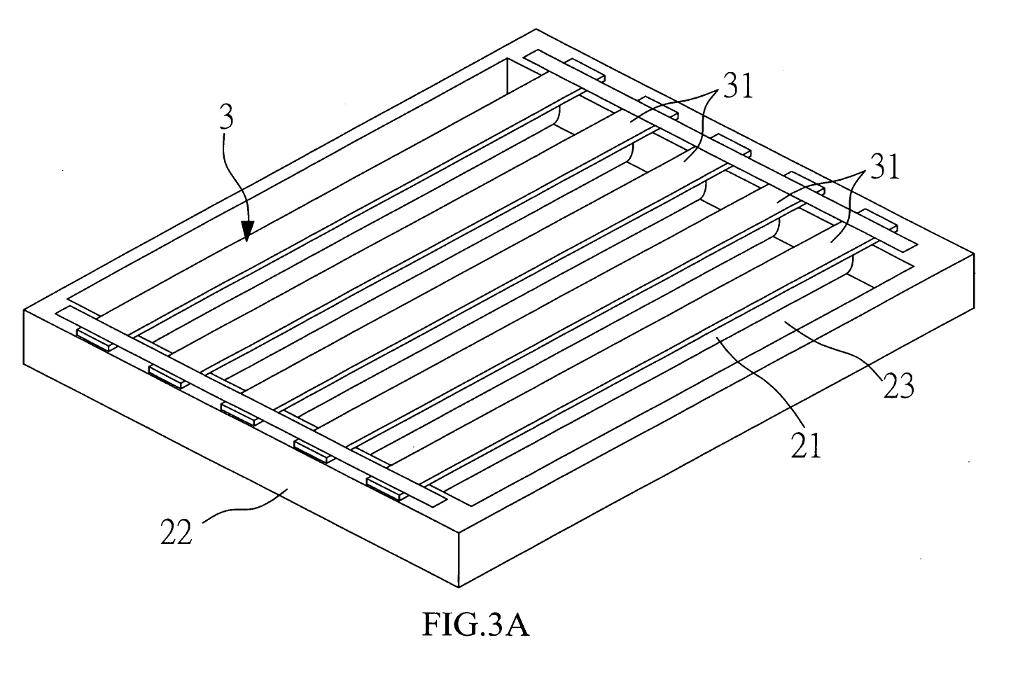

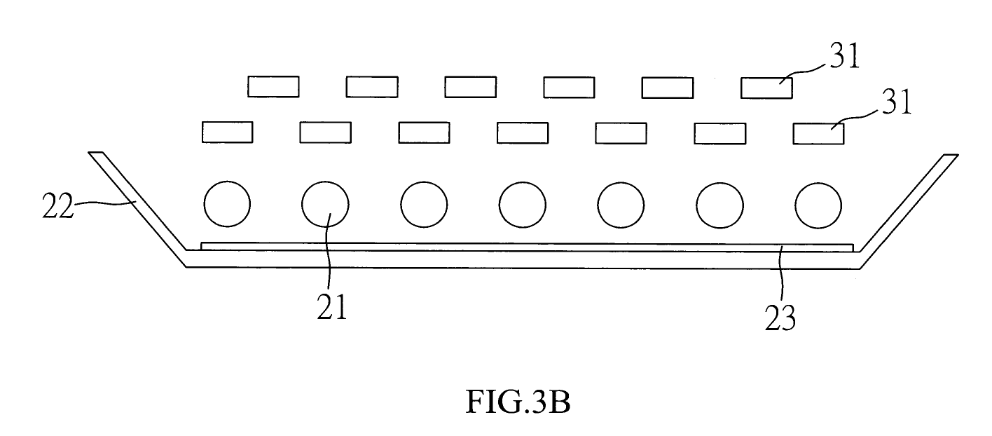

The present invention relates to an installation to upgrade light source efficiency by providing a dimmer in a backlight module in relation to the route the light emitted from the light source travels; and the dimmer in a construction that is totally permeates and/or reflects the light is disposed at where streams of light directly or indirectly radiate. As illustrated in FIG. 2, a first preferred embodiment of the present invention is related to a direct backlight module provided with a dimmer 3 on top of multiple light sources 21. Each light source 21 is related to a light emitting diode or a lamp, and the dimmer 3 is related to a single optical structure to cover up the top of those multiple light sources 21. As illustrated in FIG. 3(A) for a second preferred embodiment of the present invention, a dimmer 3 includes multiple optical structures 31 with each one assigned to an individual light source 21. As illustrated, one optical structure 31 is disposed on top of its respective light source 21, disposed between two neighboring light sources 21 in single layer or multiple layers overlapped on one another or crisscross; and those multiple optical structures 31 are provided in any combination of totally permeable, totally reflective, and totally permeable and reflective forms. As illustrated in FIG. 3(B), those optical structures 31 are respectively disposed on the top of each light source 21, between two neighboring light sources 21 in a same reflective mask 22. A reflective film 23 is disposed below those light sources 21, and the optical structure 31 is related to a totally permeable, totally reflective, or reflective and permeable form. Wherein, the totally permeable optical structure is related to a transparent film; and the reflective and permeable optical structure includes a pre-processed transparent film or a compound material. The process method is related to sandblasting, etching, atomization, disposition of dots, or macro-molecular material. Process may be applied to control reflectivity and permeability, and a reflectivity/permeability ratio can be adjusted as desired by the user.

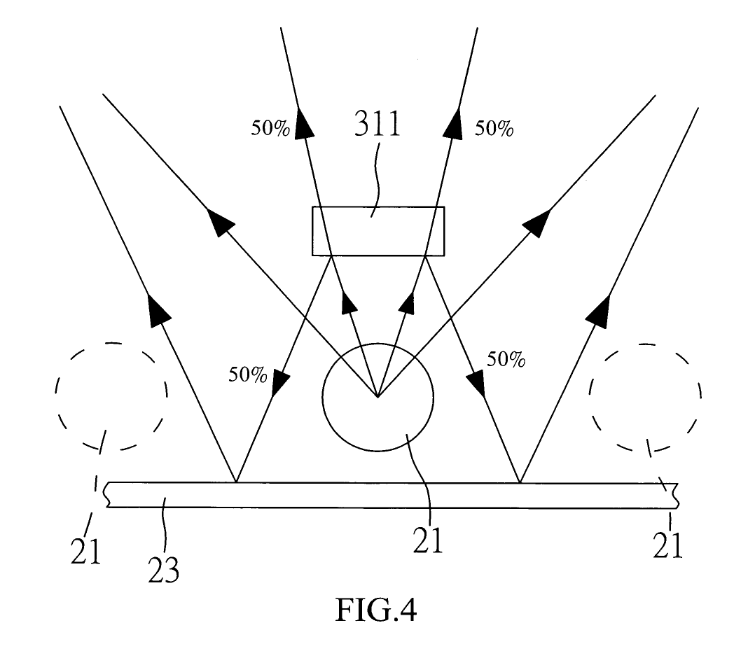

In a fourth preferred embodiment illustrated in FIG. 4 showing travel route of light emitted from each light source 21, an optical structure 311 is disposed on top of each light source 21. Both of its reflectivity and permeability are set at same 50% so that 50% of streams of light emitted from each light source 21 that go upward and pass through the optical structure 311 while another 50% of streams of light are reflected to the reflective film 23 disposed below the light source 21 before being radiated upwards so to average luminance between any light source 21 and the rest of those light sources 21 to upgrade the efficiency of the light sources 21, effectively distribute streams of light from all the light sources, and eliminate dim and dark bands otherwise created among light sources.

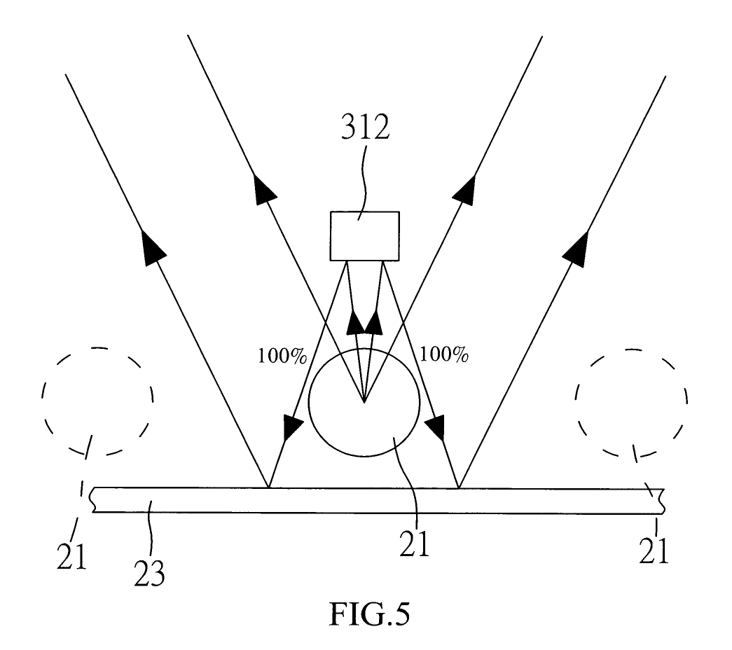

FIG. 5 shows a fourth preferred embodiment of the present invention. Wherein, a totally reflective optical structure 312 is disposed over each light source 21. All streams of light upwardly emitted from the light source 21 are reflected to the reflective film 23 disposed below the light source 21 before being upwardly radiated so to average luminance between the light source 21 and the rest of those light sources 21 to upgrade efficiency of repeated use of light while eliminating dim and dark bands otherwise existing abut any two neighboring light sources 21.

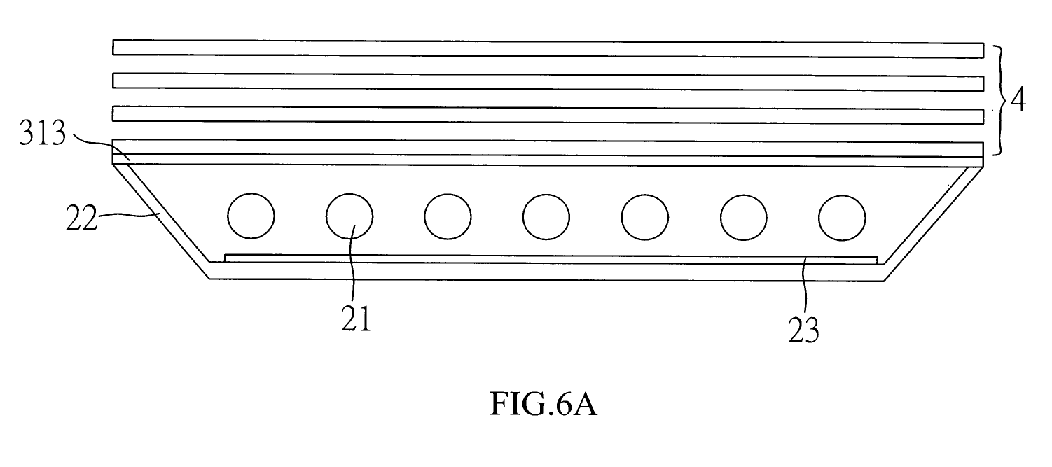

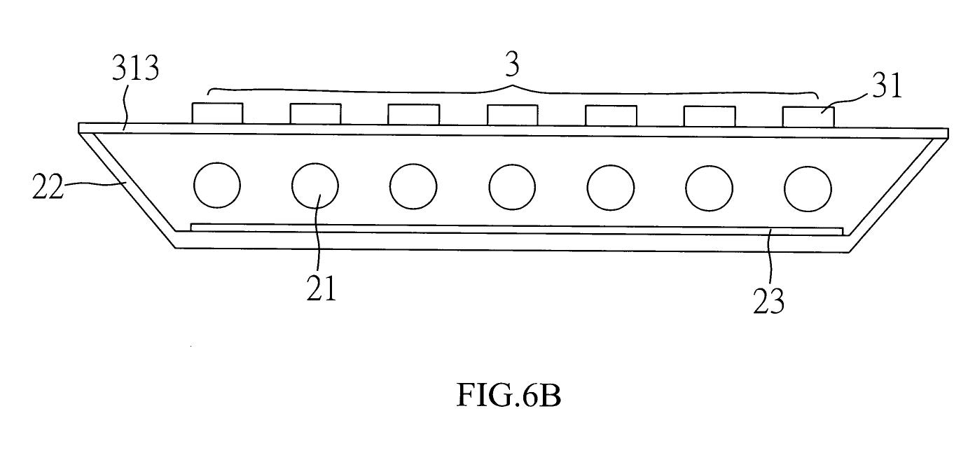

Now referring to FIG. 6(A), a fifth preferred embodiment of the present invention has a totally light permeable optical structure 313 separately provided above those light sources 21. The optical structure 313 further supports other optical film (e.g., a diffuser or a prism) and protects those light sources 21 and those optical films 4 respectively provided below and above the optical structure 313. Other optical structure 31 may be provided above the optical structure 313 in corresponding to each light source 21 as illustrated in FIG. 6(B).

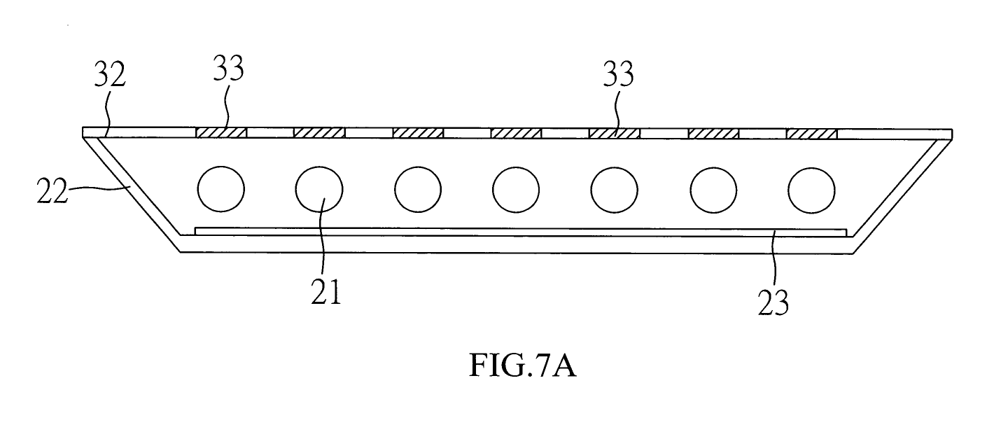

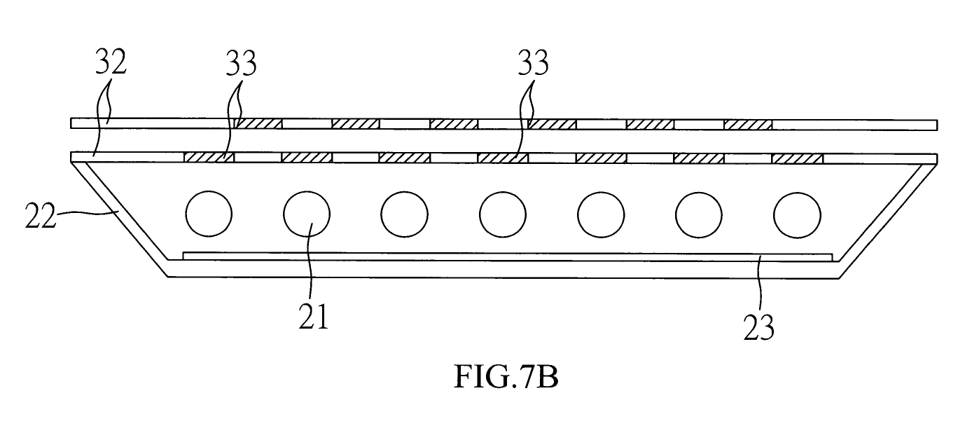

The mounting means for the dimmer 3, other than those illustrated in FIGS. 2 and 3, is provided in a sixth preferred embodiment of the present invention as illustrated in FIGS. 7(A) and 7(B) essentially by having one or a plurality of transparent film 32 or compound material to define a dimming area 33 that is totally light permeable and/or reflective or to define another dimming area comprised of any combination of multiple totally light permeable and/or reflectively dimming areas. The dimming area 33 may be processed to be located at where above or among those light sources 21.

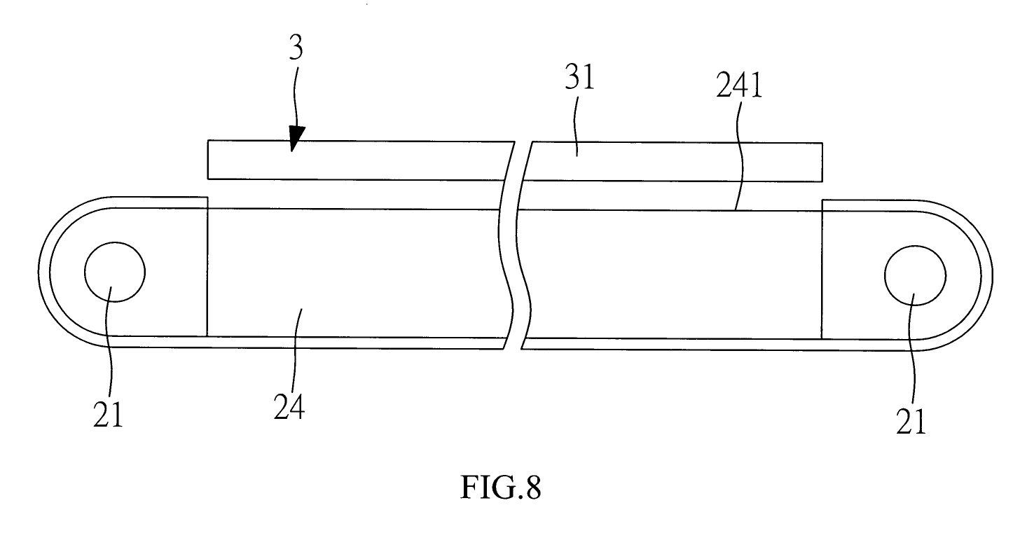

In a seventh preferred embodiment as illustrated in FIG. 8, the dimmer 3 related to a single optical structure 31 is mounted on the side of those light sources 21 to form a side emitting backlight module. As illustrated, a 2-way light input pattern is comprised of having those light sources 21 disposed on both sides of a light guide plate 24 and the optical structure 31 is provided on a light output side 241 of the light guide plate 24.

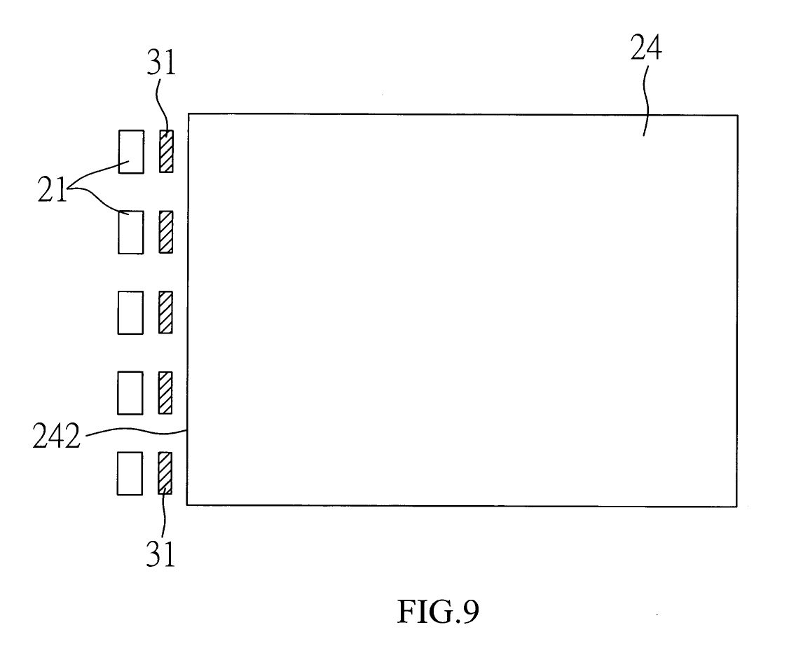

Alternatively as illustrated in FIG. 9 for an eighth preferred embodiment of the present invention, a dimmer includes multiple optical structures 31 in a quantity same as that of their corresponding light sources 21. Those light sources 21 input lights from one side of the light guide plate 24 and those optical structures 31 are disposed on the same side 242 of the light guide plate 24. The dimmer is comprised of one or a plurality of transparent film or compound material processed to define a dimming area that is totally light permeable and/or reflective and the dimming area may be provided on one side in relation to or among those light sources 21.

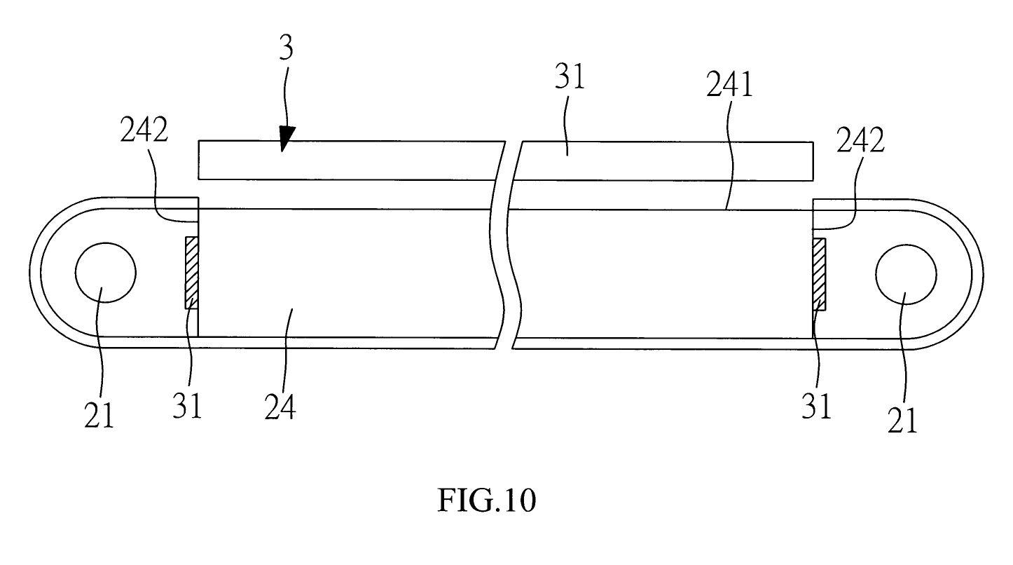

A ninth preferred embodiment of the present invention as illustrated in FIG. 10, multiple optical structures 31 are respectively provided on the light output side 241 and both sides 242 of the light guide plate 24. As illustrated in FIGS. 8, 9, and 10, the dimmer of the present invention is applied to a side emitting backlight module and mounted on the route the streams of light travel. The dimmer 3 related to an optical structure that is totally light permeable and/or reflective is capable of emitting constant streams of light and averaging luminance among those light sources, effectively eliminating those dim and dark bands among those light sources, reducing the quantity of light source needed, minimizing the use of optical films (e.g., diffuser, light enforcement film, or reflective polarizing film) in the backlight module so to more effectively distribute streams of light emitting from those light sources and upgrade the efficiency of repeated use of light.

The prevent invention provides an improved structure of an installation to upgrade light source efficiency, and this patent application is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A light source efficiency upgrading installation includes a light sources provided with a route for streams of light to travel and a dimmer disposed in relation to the route; and the dimmer is related to a totally light permeable and/or reflective optical structure.

2. The light source efficiency upgrading installation as claimed in claim 1, wherein the dimmer includes multiple optical structures in a quantity same as that of its respectively light source.

3. The light source efficiency upgrading installation as claimed in claim 1, wherein an optical from or optical structure is provided on the totally light permeable optical structure.

4. The light source efficiency upgrading installation as claimed in claim 1, wherein the dimmer is applied to a direct backlight module.

5. The light source efficiency upgrading installation as claimed in claim 1, wherein the dimmer is applied in a side emitting backlight module.

6. The light source efficiency upgrading installation as claimed in claim 1, wherein the light permeable and reflective optical structure includes a pre-processed transparent film or compound material.

7. The light source efficiency upgrading installation as claimed in claim 6, wherein the process means includes sandblasting, etching, atomizing, or mounting of dots or macromolecular compound material.

8. The light source efficiency upgrading installation as claimed in claim 1, wherein the dimmer is essentially comprised of a totally light permeable and/or reflective dimming area defined by one or a plurality of transparent film or compound material.

9. The light source efficiency upgrading installation as claimed in claim 8, wherein the dimming area is processed into that it is defined in relation to or among those light sources.

10. A direct backlight module is provided with a dimmer on the top of a light source of the backlight module at where in relation to a light travel route of the light source;
and the dimmer is related to an optical structure that is totally light permeable to and/or reflective.

11. The direct backlight module as claimed in claim 10, wherein the light permeable and reflective optical structure includes a pre-processed transparent film or compound material.

12. The direct backlight module as claimed in claim 11, wherein the process means includes sandblasting, etching, atomizing, or mounting of dots or macromolecular compound material.

13. The direct backlight module as claimed in claim 10, wherein the dimmer is essentially comprised of a totally light permeable and/or reflective dimming area defined by one or a plurality of transparent film or compound material.

14. The direct backlight module as claimed in claim 13, wherein the dimming area is processed into that it is defined in relation to or among those light sources.

15. A side emitting backlight module includes a light source, light emitting from the light source entering from a side of a light guide plate, and a dimmer is provided at where in relation to a light travel route of the light source; and the dimmer is related to an optical structure that is totally permeable to and/or reflects of light.

16. The side emitting backlight module as claimed in claim 15, wherein the light permeable and reflective optical structure includes a pre-processed transparent film or compound material.

17. The side emitting backlight module as claimed in claim 16, wherein the process means includes sandblasting, etching, atomizing, or mounting of dots or macromolecular compound material.

18. The side emitting backlight module as claimed in claim 15, wherein the light emitted from the source enters from either side of both sides of the light guide plate.

19. The side emitting backlight module as claimed in claim 15, wherein the dimmer is related to a single optical structure and is provided on the light output side of the light guide plate.

20. The side emitting backlight module as claimed in claim 15, wherein the dimmer includes multiple optical structure in a quantity same as that of their respectively light sources and are disposed on one side of the light guide plate.
